(19) United States
(12) Patent Application Publication
(10) Pub. No.: US 2004/0044909 A1
(43) Pub. Date: Mar. 4, 2004

(54) Method and system for accessing an object behind a firewall

(76) Inventors: Absar Ahmed Mirza, Co.Dublin (IE); Mark A. Sheppard, Dublin (IE); Sean Baker, Dublin (IE)

Correspondence Address: LACASSE & ASSOCIATES, LLC, 1725 DUKE STREET, SUITE 650, ALEXANDRIA, VA, 22314, US

(21) Appl. No.: 10/235,615

(22) Filed: Sep. 4, 2002

(51) Int. Cl. H04L 9/00

(52) U.S. Cl. 713/201

(57) ABSTRACT

A system and method for enabling firewalled access to a client object residing behind a firewall, via an exported callback reference, by a server object outside the firewall. The system includes callback registry accessible by a proxy operating in conjunction with the firewall. The callback registry proxifies the callback object reference so that a callback will be directed to the proxy which in turn will redirect the callback to the callback object. Callback registry, additionally, stores callback definitions, callback registration and access control policies associated with registered callback objects. These access policies are applied to the callback for the server object to ensure that only authorized objects make the callback on authorized callback objects and their operations.

### FIELD OF THE INVENTION

The field of the invention is providing security in distributed computing. More specifically, the invention relates to a method and system for providing firewalled access to client-side objects that have been exported with callback semantics.

### BACKGROUND OF THE INVENTION

In a typical client/server application, a client object sends a request to a server object to perform one or more desired operations. The server then provides a result back to the client, typically on the same TCP/IP socket used to send the request (e.g., HTTP). However, often it is desirable for the server to make a reverse invocation on the client. Such an invocation requires the server to have direct or indirect access to one or more client interfaces. In an object-oriented environment, one approach to facilitate such invocation is for a client to provide references to one or more client objects in one or more parameters passed as part of an operation invoked on the server. The server may then invoke the interfaces of the client object using the reference provided by the client-an invocation known as a “callback.” A client/server callback interaction is shown in FIG. 1, in which during step 110, a client 10 creates a callback object 15. Then, during step 120, client 10 provides a reference for callback object 15 to a server 20. And finally, during step 130, server 20 invokes an interface of callback object 15.

For clients behind a firewall, however, attempts by a server to make a callback on a client object will fail if incoming connections to client objects are blocked by the firewall. Such a failed interaction is illustrated in FIG. 2, in which during step 210, a client 10 creates a callback object 15. Then, during step 220, client 10 provides via a client-side firewall 30 a reference for callback object 15 to a server 20. Finally, during step 230, server 20 attempts to invoke an interface of callback object 15—an invocation which is blocked by firewall 30. Known approaches to overcome this problem generally result in significantly compromising the protection and/or performance provided by the firewall. These compromises include poor scaling properties and the possibility of a rogue server obtaining relatively unrestricted access to client objects or unexpected (and unauthorized/unintended) invocations on the client object.

For instance, in one approach implemented in Java RMI, known as HTTP tunneling, both an outgoing request by the client object and an incoming callback by the server object are encoded as HTTP messages. Since the client-side firewall is typically configured to allow HTTP messages directed to a web server, which generally listens on port 80, the callback encoded in the HTTP format will pass through the firewall if the callback object is started at the same port as the web server (e.g., port 80). In such situation, however, the server with the callback reference typically has unrestricted access to the client object and is also capable of accessing additional objects in the client process, or additional operations defined on the callback object. This results in a potential security breach. Moreover, only one process can be generally started on the web server's port at one time; therefore, if more processes are needed, the firewall must allow access to other ports also, which introduced further security breach.

Yet in another extension of the above approach the web server can be configured to decode the tunneled messages and pass them onto the client callback objects. In this case, the web server must understand other protocols, as well as mapping as where to send the decoded messages to. This also results in unlimited access unless web server acts as an application level firewall, which is expensive since it requires configuring web server on both the client and server sides to recognize invocation messages encoded in HTTP format and supplement web server with capabilities generally allocated to the firewalls.

In another approach often used in CORBA and RPC architectures, a bi-directional connection between the client and the server is established to provide for information exchange. In CORBA's bi-directional IIOP, for example, a client initiates a connection with a server followed by the server authenticating itself Following the server's successful authentication, a bi-directional link for exchange of information via the IIOP is established. This authentication is performed at the time of establishing the connection and like HTTP tunneling, typically provides the authenticated server relatively unrestricted access to client objects. In the event the connection is reused, such a server can access any object in the client process, or call any operation defined on a particular object instead of having limited access to the object and operation intended by the client. Once again, this results in a potential security breach.

Another CORBA approach is provided by the current CORBA firewall specification, which describes an IIOP proxy hosting a proxy object as an application-level firewall that understands IIOP messages. The IIOP proxy object is a CORBA object providing operations for firewall navigation. The IIOP proxy object provides an operation that a client may call to generate an IOR with firewall information in it, that can then be exported to the server. The server can use the IOR establish a connection to the IIOP Proxy. The proxy re-uses the existing connection with the client in a bi-directional mode to send the GIOP messages to the client. In some cases, the exported IOR would contain two profiles—a direct IOR and a proxified IOR. The server would typically attempt a direct call, and upon determining that a direct call did not work, the server would retry with the proxified IOR. This method requires a significant overhead resulting in poor scaling properties. Moreover, the use of the bi-directional mode results in the same problems associated with bidirectional IIOP.

U.S. Pat. No. 6,061,797 describes a firewall mechanism for securing calls to callback objects. In the system described, a firewall (or an agent behind it) can check if a call should be allowed to flow through to the target object if it has an entry (a tuple) in security tables that contain the host and port-number of the target object and the host_port-number of the caller. This system has significant disadvantages, because all methods of the target object are available to the caller; and the caller may not be able to pass the object reference of the target to another object that will call the target object (there may be no entry for that second potential caller in the table in the firewall/agent).

### SUMMARY OF THE INVENTION

The present invention comprises a method and system for automatic proxying of callback references to provide access to client objects behind a firewall without requiring creation of numerous proxy objects. The invention enables a client object to provide a functional callback reference to a server object to make a reverse invocation on the client object while limiting access via the callback at the level of operations that may be invoked, the client objects available via the callback, and the manner of generating the callback references. To this end, the invention provides for callback definition, callback registration, and callback control.

The invention has several aspects that span a range of levels of abstraction in an invocation cycle. They range from low-level filtering techniques to higher-level and application-level manipulations. These mechanisms enable export of object references outside of a firewall domain for transparent manipulation by the outside server in their proxified form. The mechanisms also provide security policies to be applied to reverse invocations from outside the firewall.

In one aspect of the invention, no lasting connection is required (e.g. bi-directional IIOP) and instead the firewall is used as part of the solution. Moreover, the security policies employed for regulating callback access may be dynamically specified.

In another aspect of the invention, a callback registry collects and stores security policies associated with the callback object so that only authorized callbacks are allowed. The security policies include granularity of access, type of access, and operations permitted on the client object. These policies are preferably accessed by the proxy when a callback is received from the server object.

In a preferred embodiment of the invention, the callback is registered in a callback registry by specifying the callback target and associated callback operations for that target. The callback registry preferably generates a proxified callback reference having a return address and port of the proxy so that a callback from an external server object is directed to the proxy. Upon callback, the proxy applies set security policies associated with the registered callback and decides whether to forward the callback to the client object.

Another preferred embodiment of the invention comprises a low level filtering technique for automatic proxification of a callback object reference. An proxy continuously monitors the outgoing data stream, and upon interception of a callback setup, automatically registers it, and replaces the callback reference with a proxified callback reference in the data stream.

Although the present invention is described in detail with reference to the preferred CORBA embodiment, many aspects of the invention are not limited to the CORBA environment, but may be used in any distributed computing environment such as Java (e.g. using RMI), DCE, RPC, NEO and others.

### DESCRIPTION OF THE DRAWINGS

The following figures help describe some embodiments of the invention for a more complete understanding. The figures are merely illustrative and, thus, do not limit the scope of the invention.

FIG. 1 is a schematic diagram of a network configuration illustrating client/server interactions.

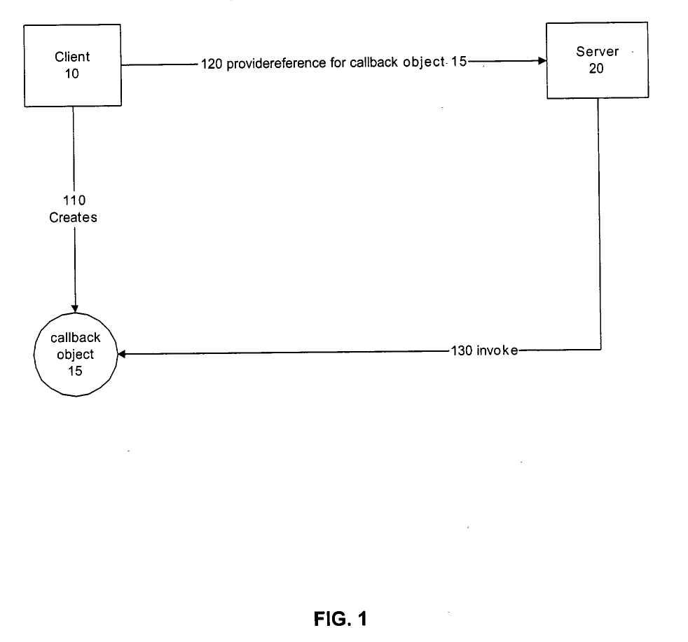

FIG. 2 is a schematic diagram of a network configuration illustrating client/server interactions with a client-side firewall.

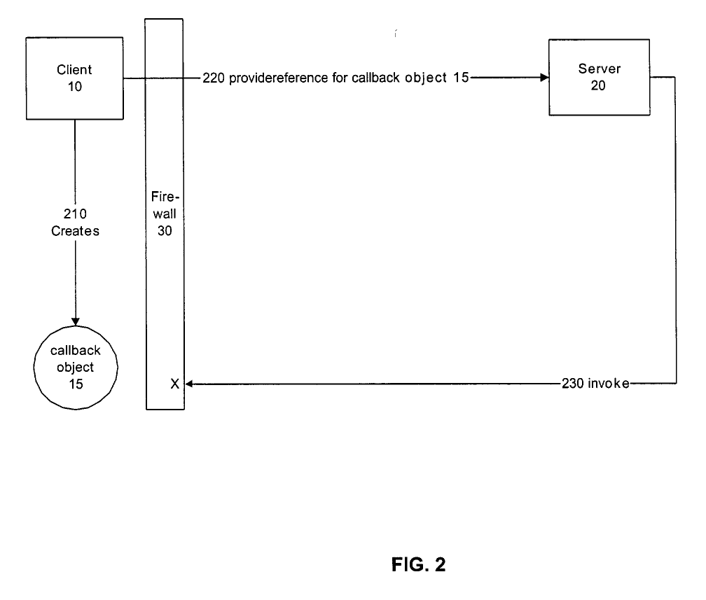

FIG. 3 is a schematic diagram of a network configuration in accordance with a preferred example embodiment of the invention.

FIG. 4 is a schematic diagram of a network configuration in accordance with another example embodiment of the invention.

FIG. 5 is a flow diagram of the callback registration process in accordance with a preferred example embodiment of the invention.

FIG. 6 is a flow diagram of the callback registration process in accordance with another preferred example embodiment of the invention.

FIG. 7 is a flow diagram of the callback registration process in accordance with yet another preferred example embodiment of the invention.

FIG. 8 is a flow diagram of the callback setup in accordance with a preferred example embodiment of the invention.

FIG. 9 is a schematic diagram of the callback registry database in accordance with a preferred example embodiment of the invention.

### DETAILED DESCRIPTION OF THE INVENTION

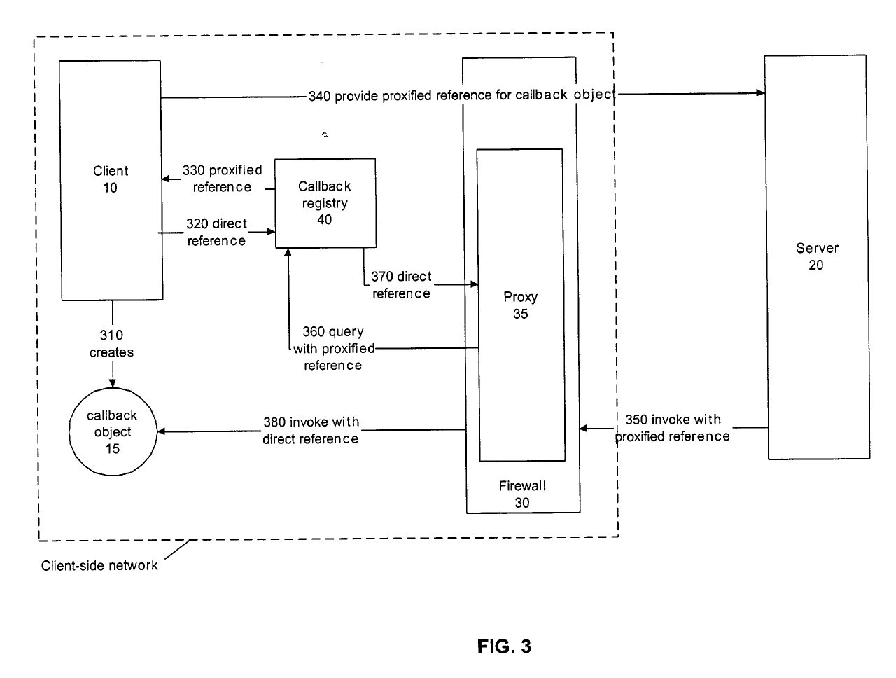

The present invention comprises a method and system for securely supporting a connection between a first object residing behind a firewall and a second object residing on an remote server and capable of invoking at least one operation on the first object. “Object” as used herein means any computational entity capable of sending or receiving a message. In a preferred embodiment, the invention is adapted to facilitate callback interactions between a client object and a server. More particularly, the server object makes a callback on the client object that is protected by a firewall using a callback reference that does not compromise the firewall. FIG. 3 schematically depicts an example preferred architecture and client/server interaction in accordance with a preferred embodiment. The example preferred client-side architecture comprises a client 10 and a callback object 15 residing behind a firewall 30 having a proxy 35 and a callback registry 40.

Firewall 30 allows outgoing connections to be established by client 10 while prohibiting incoming connections originating from external computers. In conjunction with firewall 30, proxy 35 preferably facilitates delegation of the requests between a server object residing on an external remote server 20 and a callback object 15. Proxy 35, in turn, utilizes callback registry 40, which preferably stores callback registration and proxification information.

With reference to FIG. 3, one preferred method of securely providing a connection between callback object 15 residing behind firewall 30 and a server object residing on remote server 20, involves the following steps. During step 310, client 10 creates callback object 15. Alternatively, callback object 15 may be created by another object, such as a factory object. Callback object 15 preferably has an object reference, which is used to invoke callback object 15, such as a CORBA interoperable object reference (IOR). Such reference may contain for example, the name of the host on which object 15 resides, the port it listens to, and an object identifier. The object identifier preferably is a unique value that identifies object 15 on its host computer.

During step 320, client 10 registers callback object 15 in callback registry 40. The registration preferably involves client 10 passing the object reference of callback object 15 to callback registry 40. Callback registry 40 preferably: (1) generates a proxified object reference (2) stores both the callback object reference and the proxified object reference, and (3) returns the proxified reference to client 10 during step 330, so it can be exported to server 20 during step 340. In one preferred embodiment, callback registry 40 proxifies the object reference by replacing addressing information of the host on which callback object 15 resides with the addressing information of proxy 35, so that a callback is directed to proxy 35. Preferably, in a CORBA IOR, the name of the host on which callback object 15 resides and the port to which callback object 15 listens are replaced with the name and the port of proxy 35. The object identifier within the object reference may be also modified to provide an extra level of security. Alternatively, the proxy information is included in the proxified object reference along with the original callback object reference information.

In another aspect of the invention, the registration preferably may further involve client 10 specifying with callback registry 40 security policies associated with callback object 15 that are to be applied to callback invocations. These security policies specify which servers may invoke which callback objects for which purposes. The security policies may generally be divided into two categories: identity-based and rule-based.

The identity-based policies preferably include individual-based policies and group-based policies. An individual-based policy is typically expressed in terms of a list for each callback object 15 stating which server object may invoke which operations on the client object 15. Preferably, the default set of operations is the set of all possible operations on callback object 15; however, access to these operations can be controlled via an access specifier. Such access specifier may take, for example, values “allow” or “deny” for any operation. Values of the access specifier are preferably set by an administrator. In a group-based policy, a number of objects may be specified as members of a group and may be subjected to policies as a group. This makes group-based policies easier and more efficient to express and to implement than individual policies. Furthermore, a group policy enables server 20 to pass proxified object reference to any object identified in the policy to perform the callback regardless of whether server object resides on server 20 or some other server.

The rule-based policies preferably include multi-level policies and compartment-based policies. In a multi-level policy, each callback object is assigned a clearance level, which reflects degree of its accessibility. For example, a callback object having a predetermined clearance level may be accessed via an invocation on an object having higher-level of clearance, but may not be accessed via an invocation on a lower-level object. In a compartment-based policy, a set of callback objects are associated with a particular security compartment or category, which isolates them from other callback objects. Preferably, the server object requires a distinct clearance for compartment to be able to invoke on objects in that compartment. Moreover, invocations in a compartment may be subject to special rules. For example, a rule may specify that within a particular compartment, two callback objects cannot be invoked simultaneously.

Furthermore, security polices may be arranged in a hierarchical manner, so that application of a particular policy to the callback object invocation may trigger application of another policy and so on. Moreover, it must be understood by one skilled in the art that multiple exceptions to the predefined set of security polices may be specified.

Identity-based security policies are preferably realized using access control lists (“ACL”). An ACL is an attribute of a callback object, stating which server objects can invoke which operations on it. In other words, when a callback is received by proxy 35, the callback must comply with the corresponding ACL record. Maintenance of the ACL and enforcement of the security policies is preferably the responsibility of callback registry 40.

Rule-based security policies are preferably realized using capabilities. A capability is effectively a ticket, possessed by an initiator, which authorizes the holder to access a specified target in specified ways. Capabilities can be passed from one user to another, and cannot be altered or fabricated by anyone apart from the responsible authority. The capabilities of known objects residing on a server 20 or a different server are preferably stored in callback registry 40.

In another aspect, registration may further involve client 10 specifying a granularity parameter describing access to a set of objects having common characteristics. Examples of such a set include objects accessible via a specified interface, via a specified host, or a group of arbitrary specified objects. In a CORBA environment, such set may further include objects accessible via a specified portable object adapter (“POA”). The granularity improves scaling behavior and management of callback objects.

In yet another aspect, ACL records preferably support security policies associated with specified levels of granularity, thus improving scaling behavior and management of callback objects.

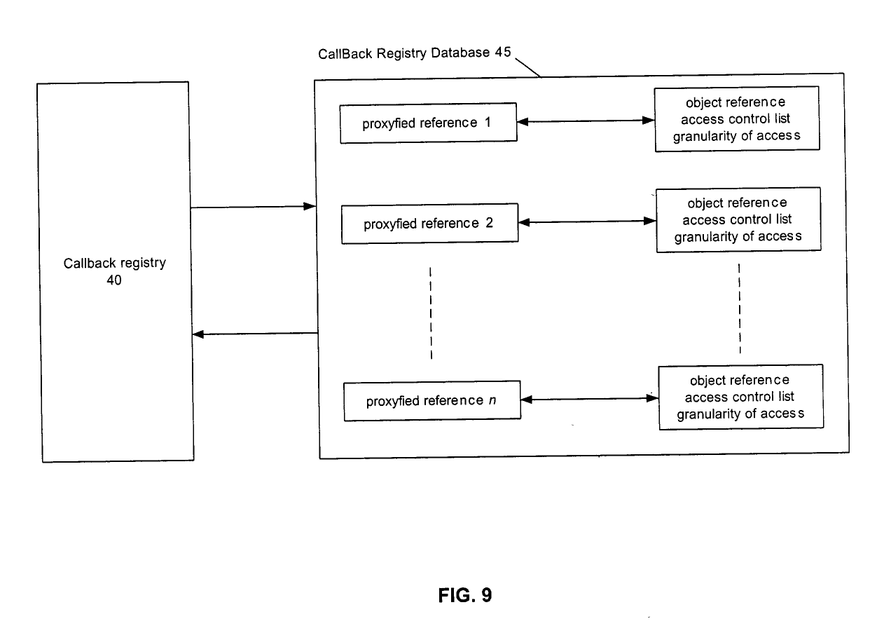

Object references and the associated proxified references, the ACL records, and capabilities are preferably stored in a callback registry database to facilitate efficient search and retrieval of the callback objects' registration information. FIG. 9 shows an example preferred callback registry database to illustrate an aspect of callback reference management, e.g., in the context of FIG. 3. New entries in registry database 45 are made at the time of registration of a new callback object. These entries can be preferably updated by callback object 15 any time after callback registration but preferably prior to actual callback; updates may be made, for example, to reflect changes in security policies of the callback object.

Registry database 45 is preferably indexed on both the object reference and proxified object reference for each entry. In one preferred embodiment, only a portion of the object reference and proxified object reference, such as the object key of a CORBA IOR, form the index key. Registry database 45 is preferably queried using the object reference when a callback is registered by client 10 or when an entry is updated. Registry database 45 is preferably queried using the proxified reference when a callback from server 20 is received by proxy 35.

During step 350, server 20 sends a callback request to callback object 15 via proxy 35 using the proxified reference. Server 20 may provide the proxified reference to one or more objects to perform callbacks. Callbacks are directed to proxy 35 based on the proxified object reference.

Proxy 35 is preferably protocol-specific, i.e., it understands the communication protocol used by client 10 and server 20 and may also perform operations such as auditing or monitoring of the network traffic. Proxy 35 preferably listens on a specific port for callbacks containing invocations on at least one operation provided by callback objects such as callback object 15. Upon reception, proxy 35 preferably extracts the proxified reference from the callback data stream and requests the callback registry 40 to resolve the corresponding object reference for the destination callback object. In particular, proxy 35 passes the proxified reference to callback registry 35, which queries registry database 45 to determine whether a callback object identified by the object identifier withing the proxified reference has been registered. If found, the callback registry retuns the corresponding object reference of callback object 15 to proxy 35.

Preferably, proxy 35 also passes to callback registry 45 the name(s) of the operation(s) being invoked by the callback. Callback registry 45 checks the corresponding ACL record whether such operation(s) is (are) allowed. Preferably, registry 45 also checks a granularity of access permitted to the callback. Alternatively, access control and/or granularity may be checked by proxy 35. If both of these parameters are resolved positively, proxy 35 forwards the callback to callback object 15. If any operation being invoked on callback object 15 by server 20 is not allowed, the callback is preferably blocked. Alternatively only the disallowed operations are blocked.

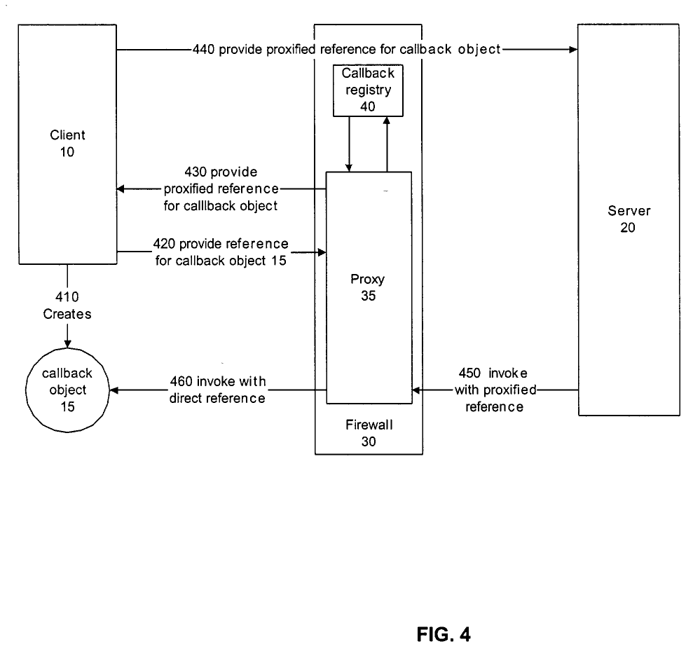

In another embodiment, client 10 preferably does not invoke on the callback registry 40 directly but via proxy 35. With reference to FIG. 4, during step 410, client 10 creates callback object 15. During step 420, client 10 sends the callback object reference to proxy 35 to be registered and proxified with callback registry 40. Proxy 35 preferably queries callback registry 40 to determine whether callback reference has already been proxified. If callback object reference has not been proxified yet, callback registry 40 preferably (1) proxifies the object reference (preferably by replacing addressing information of the host on which callback object 15 resides with the addressing information of proxy 35, so that a callback is directed to proxy 35), (2) stores both the callback object reference and the proxified object reference, and (3) returns the proxified object reference to proxy 35. During step 430, proxy 35 forwards the proxified callback reference to client 10 to be exported to server 20 during step 440. Upon callback from server 20, proxy 35 preferably extracts the proxified reference from the callback data stream and requests the callback registry 40 to resolve the corresponding object reference for the destination callback object. In a preferred CORBA embodiment, proxy 35 passes the proxified reference to callback registry 40, which queries the registry database to determine whether a callback object identified by the object identifier of the proxified reference has been registered. If found, callback registry returns the corresponding object reference of callback object 15 to proxy 35. Preferably, proxy 35 also passes to callback registry 40 the name(s) of the operation(s) being invoked by the callback. Callback registry 40 checks the corresponding ACL record whether such operation(s) is (are) allowed. Preferably, registry 40 also checks a granularity of access permitted to the callback. If both of these parameters are resolved positively, proxy 35 forwards the callback to callback object 15. If any operation being invoked on callback object 15 by server 20 is not allowed, the callback is preferably blocked. Alternatively only the disallowed operations are blocked.

The following code illustrates some features of the above-described system by supporting a connection between a CORBA callback object residing behind a firewall and a server object residing on an external remote host. Particularly, the code illustrates a callback registry interface that provides callback object registration having various levels of granularity with separate ACL records.

interface Proxy_Callback_Registry
{

// Data type specifying access policy to the callback object
enum AccessPolicy
{

internal-allow,
external-allow,
internal-deny,
external-deny

};
// Data type specifying granularity of access to a set of objects
enum ObjectGranularity {Object, POA, Interface, Server};

typedef String POAname_t;
typedef String Interfacename_t;
typedef String Servername_t;

// Data types specifying access control policies for every granularity
of access
struct ObjectAccessControlPolicy
{

AccessPolicy access;
Object callback_reference;
String operation_name;

};
struct POAAccessControlPolicy
{

AccessPolicy access;
POAname_t poa_{'}name;
String operation_name;

};
struct InterfaceAccessControlPolicy
{

Interfacename_t interface_name;
String operation_name;
AccessPolicy access;

};
struct ServerAccessControlPolicy
{

AccessPolicy access;
Servername_t server_name;
String operation_name;

};
typedef sequence<ObjectAccessControlPolicy>

CallBackObjectSecurityPolicy_t;

typedef sequence<POAAccessControlPolicy>

CallBackPOASecurityPolicy_t;

typedef sequence<InterfaceAccessControlPolicy>

CallBackInterfaceSecurityPolicy_t;

typedef sequence<ServerAccessControlPolicy>

CallBackServerSecurityPolicy_t;

// Operations providing registration for callback objects
Object register_callback_object
(

in Object callback_reference,
in CallBackObjectSecurityPolicy_t object_security_policy

);
Object register_callback_POA
(

in POAname_t callback_poa_name,
in CallBackPOASecurityPolicy_t poa_security_policy

);
Object register_callback_Interface
(

in Interfacename_t callback_interface_name,
in CallBackInterfaceSecurityPolicy_t interface_security_policy

);
Object register_callback_Server
);

in Servername_t callback_server_name,
in CallBackServerSecurityPolicy_t server_security_policy

);
// Operations providing functionality to unregister callback objects
boolean unregister_callback_object

(in Object callback_reference);

boolean unregister_callback_poa

(in POAname_t callback_poa_name);

boolean unregister_callback_interface

(in Interfacename_t callback_interface_name);

boolean unregister_callback_server

(in Servername_t callback_server_name);

};

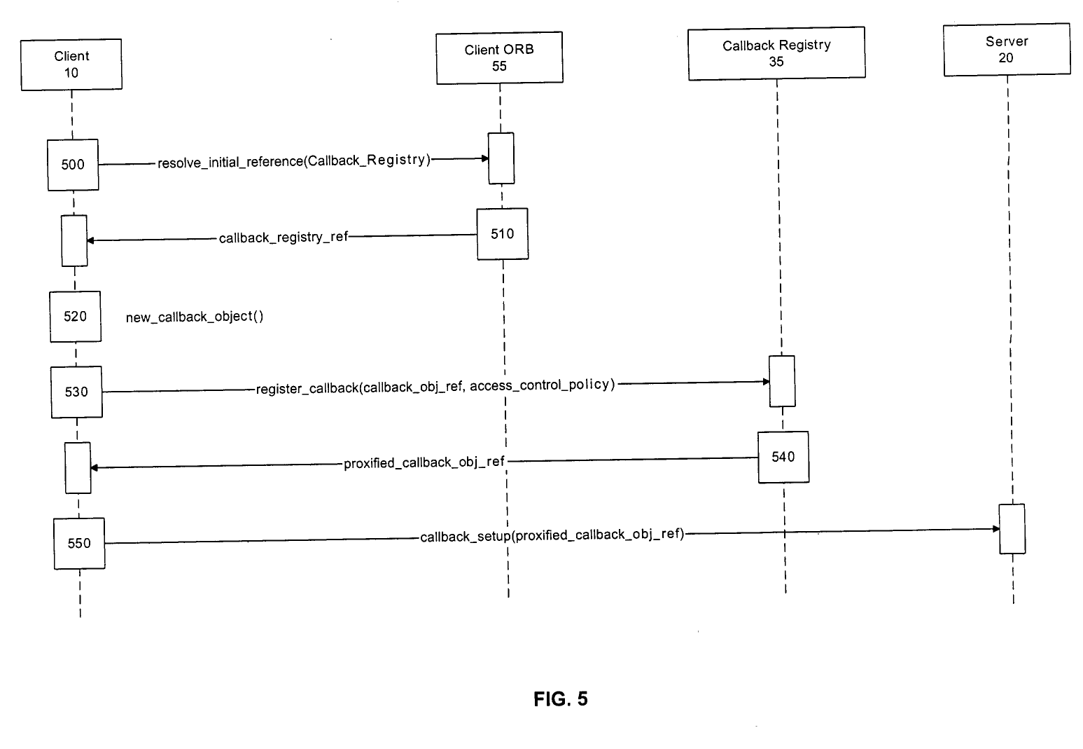

An example preferred method, illustrated in FIG. 5, enables server 20 residing outside firewall 30 to access, via an exported callback reference, a CORBA callback object 15 of client 10. Preferably, firewall 30 hosts a GIOP/IIOP proxy 35 configured to support GIOP and IIOP connections between CORBA objects. Firewall 30 may further provide ports for various protocols with a port for each of HTTP, HTTPS, SSL, and the like.

Initially, during steps 500 and 510, client 10 contacts an ORB 55 to acquire a reference of the callback registry 150. Once this reference is acquired the registration process can be launched. During step 520, client 10 creates a new callback object 15. During step 530, client 10 invokes register_callback on callback registry 40 and passes the object reference of callback object 15 and the associated security policies as parameters to invocation. Preferably, the object reference is a CORBA IOR. During step 540, the proxified reference is returned by callback registry 40 to client 10, so it can be exported to server 20 during step 550. The proxified callback reference is preferably a reference for proxy 35, and preferably comprises a CORBA IOR comprising an address of the host and port number of GIOP/IIOP proxy 35, so the callback is directed to GIOP/IIOP proxy 35. Moreover, the object key in the object reference may be modified also to provide extra level of security. The callback reference, the proxified reference, and associated security policies are stored in registry database 45. In particular, the security policies are preferably stored in an ACL. These security policies can be updated any time after callback registration but preferably prior to actual callback via set_security_policy illustrated below:

void set_object_security_policy
(

in Object callback_reference,
in CallBackObjectSecurityPolicy_t object_security_policy

);
void set_POA_security_policy
(

in POAname_t callback_poa_name,
in CallBackPOASecurityPolicy_t poa_security_policy

);

void set_interface_security_policy

(

in Interfacename_t callback_interface_name,
in CallBackInterfaceSecurityPolicy_t interface_security_policy

);
void set_server_security_policy
(

in Servername_t callback_server_name,
in CallBackServerSecurityPolicy_t server_security_policy

);

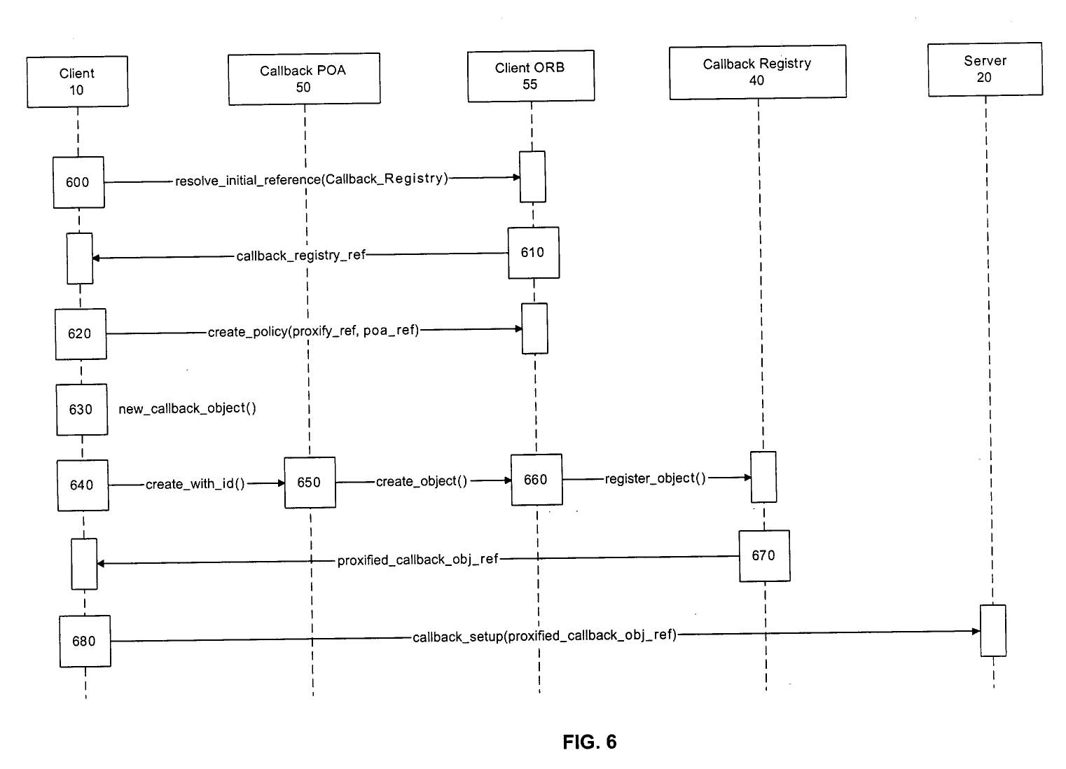

Referring now to FIG. 6, in another example embodiment, callback object 15 is registered via an ORB 55 preferably configured to automatically register objects created in a particular POA. To this end, client 10 preferably does not invoke on callback registry 40 directly, but via ORB 55. Such configuration provides improved flexibility and scalability in the design and management of the client-side firewall infrastructure since it reduces client's need for knowledge of the firewall and the interactions between the ORB, POAs, and the callback registry.

During steps 600 and 610, client 10 contacts ORB 55 to acquire a reference for callback registry 40. Once this reference is known the registration process can be launched. During step 620, client 10 creates a new policy in ORB 55 that preferably authorizes ORB 55 to automatically register all objects created in a callback POA 50. During steps 630, 640, and 650, client 10 creates a new callback object 15 in callback POA 50. During step 660, client ORB 55 automatically invokes an appropriate register_callback operation on callback object 15. During step 670, callback registry 40 registers callback object 15 by proxifying its object reference, storing the object reference, the proxified reference, and associated security policies into registry database 45, and returns the proxified reference to client 10. Finally, during step 680, the proxified reference is exported to server 20.

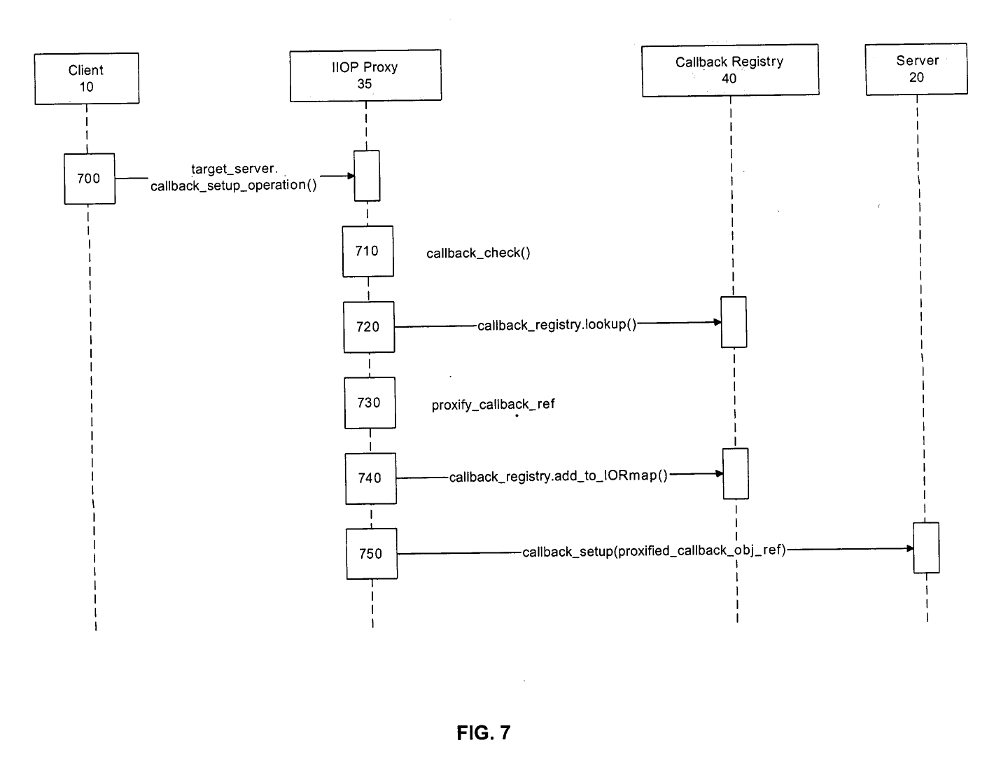

Referring now to FIG. 7, in yet another example embodiment, client 10 is preferably configured to send/receive all of the IIOP data traffic to/from GIOP/IIOP proxy 35, which monitors on a specified port client's 10 message stream to filter the callback setup pattern. Preferably, client 10 is configured to include in its callback setup request the object reference of callback object 15 and associated security policies. This defines a message of a pattern that GIOP/IIOP proxy 35 is configured to detect and intercept in the client message stream.

During step 700, client 10 dispatches a callback setup request to server 20 via GIOP/IIOP proxy 35. The callback setup request comprises the object reference of callback object 15 and associated security policies. During step 710, GIOP/IIOP proxy 35 detects and intercepts the callback setup request in the outgoing data stream and extracts the object reference and the associated security policies. During step 720, GIOP/IIOP proxy 35 contacts callback registry 35 to determine whether callback object 15 has been already registered. If callback object 15 was already registered, GIOP/IIOP proxy 35 updates associated ACL record with the new security policies and replaces the object reference with the proxified reference. If callback object 15 was not registered yet, during steps 730 and 740, GIOP/IIOP proxy 35 passes the object reference and the associated security policies to callback registry 40, which proxifies the object reference and preferably adds it to the registry database 45 together with the associated security policies. Finally, during step 750 the callback setup request comprising the proxified reference is dispatched to server 20.

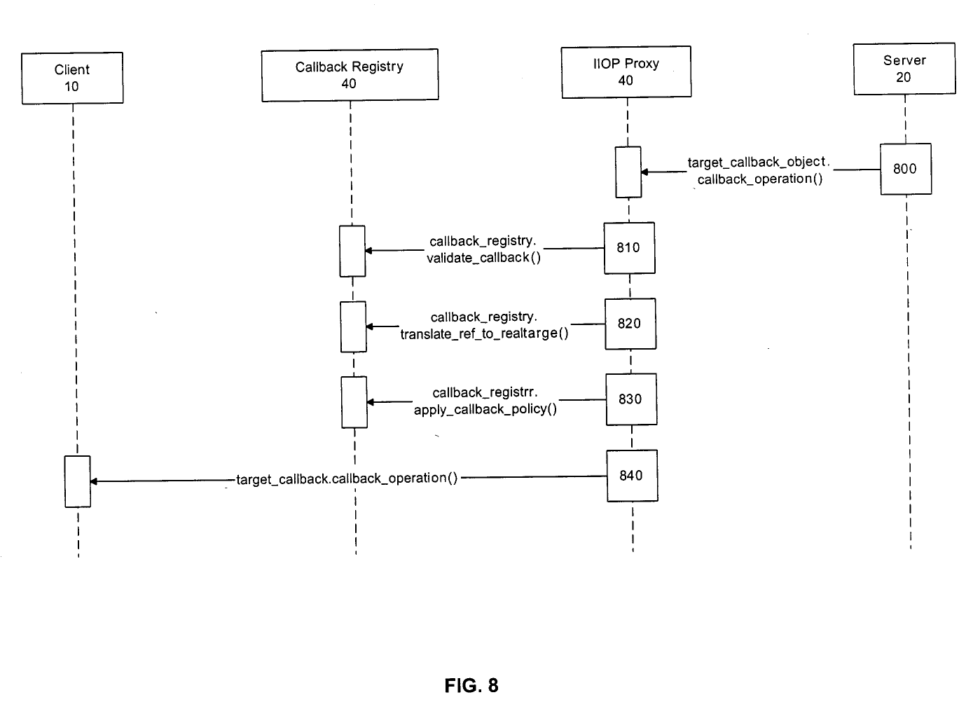

With reference to FIG. 8, in an example preferred embodiment, GIOP/IIOP proxy 35 and callback registry 40 interactions during a callback are illustrated. In particular, GIOP/IIOP proxy 35 listens on a specific port for a callback from server 20 preferably containing an invocation on at least one operation provided by callback object 15. Upon reception, GIOP/IIOP proxy 35 preferably extracts the proxified reference from the callback data stream and contacts callback registry 40 during step 810 to resolve the corresponding object reference for the destination callback object. In particular, during step 820, GIOP/IIOP proxy 35 passes the proxified reference to callback registry 40, which queries registry database 45 to determine whether a callback object identified by the object identifier within the proxified reference has been registered. If a callback object is found, callback registry 40 returns the corresponding object reference of the callback object 15 to GIOP/IIOP proxy 35.

Preferably, during step 830, proxy 35 also passes to callback registry 40 the name(s) of the operation(s) being invoked in the callback. Callback registry 40 checks the corresponding ACL record whether such operation(s) is (are) allowed. Preferably, registry 40 also checks a granularity of access permitted to the callback. If both of these parameters are resolved positively, during step 840, GIOP/IIOP proxy 35 forwards the callback to callback object 15.

In an alternative embodiment, some or all of the functions of registry database 45 are performed by storing object reference information for the callback object and/or security information such as an ACL in the proxified object reference. Preferably the callback object reference information and/or security information stored in the proxified object reference is encrypted in a manner to be difficult to decrypt by unauthorized entities, but easily decrypted by proxy. When proxy receives a callback invocation using such object reference, proxy decrypts the encrypted information and uses the callback object reference information to open a connection with and invoke the callback object, possibly after determining whether security requirements encoded in the proxified reference have been met. In this way the need for bidirectional IIOP or other persistent connection between the callback object and the proxy is eliminated.

In another alternative embodiment, security information such as an ACL is stored in a security server, such as a Lightweight Directory Access Protocol server. This approach may be combined with a callback registry which need not store security information, or alternatively, with the embodiment described above in which callback object reference information is stored in the proxified object reference, obviating the need for a callback registry entirely.

The embodiments described herein are merely illustrative and are not intended to limit the scope of the invention. One skilled in the art may make various changes, rearrangements and modifications to the illustrative embodiments described above without substantially departing from the principles of the invention, which is limited only in accordance with the claims.

The present invention may be used to implement a load-balancing system in which more than one, perhaps many, instances of callback handlers on different physical machines can be used to process multiple callback invocations using the same object reference. Callback invocations may be distributed by the proxy to the multiple callback handler instances as they are received.

In addition, the present invention may advantageously be implemented as a plug-in in the same process as a packet filter or other firewall process, reducing computational overhead.

What is claimed is:

1. A method for enabling access to a first object residing behind a firewall, via a reference, by a second object outside the firewall, the method comprising the steps of:
generating a reference;
registering the reference with a registry accessible to a proxy agent, the proxy gent being accessible by the second object;
receiving a proxy reference associated with the reference;
sending the proxy reference to the second object outside the firewall; and
receiving an invocation on the first object from the second object, via the proxy agent.

2. The method of claim 1, wherein the proxy reference identifies a host and port corresponding to the proxy agent.

3. The method of claim 1, further comprising the step of forwarding the proxy reference to a third object to perform an invocation on the first object.

4. The method of claim 1, further comprising the step of specifying one or more security policies associated with the first object.

5. The method of claim 4, wherein the security policies define operations permitted on the first object.

6. The method of claim 5, wherein the security policies are recorded in an access control list.

7. The method of claim 4, wherein the security policies define objects that are permitted to invoke operations on the first object.

8. The method of claim 7, wherein the security policies are recorded in a capability list.

9. The method of claim 4, further comprising the step of specifying exceptions to the specified security policies.

10. The method of claim 4, wherein the security policies are applied to at least one category of objects.

11. The method of claim 10, wherein the category of objects comprise all objects accessible via a portable object adapter (“POA”), all objects accessible via a host, all objects accessible via a specific interface, or a defined set of one or more objects.

12. The method of claim 11, wherein the security policy further specifies whether invocations from at least one category of objects are allowed or denied.

13. The method of claim 4, wherein the security policy associated with the first object can be updated after the proxy reference has been exported.

14. The method of claim 1, further including the step of specifying a granularity of access associated with the reference.

15. The method of claim 14, wherein the granularity of access associates the reference with at least one member of the set consisting of all objects accessible via a portable object adapter (“POA”), all objects accessible via a host, all objects accessible via specific interface, and a defined set of one or more objects.

16. The method of claim 1, further including the step of configuring an request broker to implicitly call the proxy agent to obtain the proxy reference, whereby all interactions between the first object and the proxy agent are done via the request broker.

17. A method for enabling access to a first object residing behind a firewall, via a reference, by a second object outside the firewall, the method comprising the steps of:
detecting the reference in an outgoing data stream;
registering the reference and a corresponding proxy reference in a callback registry;
replacing the reference in the outgoing data stream with the corresponding proxy reference; and
receiving an invocation from the second object, via the proxy agent.

18. The method of claim 17, wherein the proxy reference identifies a host and port corresponding to the proxy agent.

19. The method of claim 17, further comprising the step of forwarding the proxy reference to a third object to perform an invocation on the first object.

20. The method of claim 17, further comprising the step of specifying one or more security policies associated with the first object.

21. The method of claim 20, wherein the security policies define operations permitted on the first object.

22. The method of claim 21, wherein the security policies are recorded in an access control list.

23. The method of claim 20, wherein the security policies define objects that are permitted to invoke operations on the first object.

24. The method of claim 23, wherein the security policies are recorded in a capability list.

25. The method of claim 20, further comprising the step of specifying exceptions to the specified security policies.

26. The method of claim 20, wherein the security policies are applied to at least one category of objects.

27. The method of claim 26, wherein the category of objects comprises all objects accessible via a portable object adapter (“POA”), all objects accessible via a host, all objects accessible via a specific interface, or a defined set of one or more objects.

28. The method of claim 26, wherein the security policy further specifies whether invocations from at least one category of objects are allowed or denied.

29. The method of claim 20, wherein the security policy associated with the first object can be updated after the proxy reference has been exported.

30. The method of claim 17, further including the step of specifying a granularity of access associated with the reference.

31. The method of claim 30, wherein the granularity of access associates the reference with at least one member of the set consisting of all objects accessible via a portable object adapter (“POA”), all objects accessible via a host, and all objects accessible via specific interface.

32. The method of claim 17, further including the step of configuring an ORB to implicitly call the proxy agent to obtain the proxy reference, whereby all interactions between the first object and the proxy agent are done via the ORB.

33. A database for storing at least one reference and a plurality of associated parameters, said parameters comprising:
a proxy reference for directing an invocation to a proxy agent; and
an access control list containing security policies applied to the invocation.

34. The database of claim 33, wherein said parameters further include a granularity of access associating the reference with at least one member of the set consisting of objects accessible via a portable object adapter (“POA”), objects accessible via a host, objects accessible via specific interface, and a defined set of one or more objects.

35. The database of claim 33, that is updated in response to either monitoring a message stream or registration by an object.

36. A firewall enabling access to a first object, via a proxy reference, by a second object, the firewall comprising:
a proxy agent capable of intercepting a reference from the first object directed to he second object; and
a callback registry in electrical communication with said proxy agent and capable of registering the reference, wherein the registration comprises:
generating a proxy reference so that an invocation from the second object is directed to the proxy agent; and
storing the reference and proxy reference.

37. The firewall of claim 36, wherein the registration further comprising:
storing security policy associated with the first object; and
storing granularity of access to the first object.

38. A method for enabling access to a first object residing behind a firewall, via a reference, by a second object outside the firewall, the method comprising the steps of:
generating a reference to the first object;
receiving a proxy reference associated with the reference;
sending the proxy reference and an identifier of the first object to the second object outside the firewall; and
receiving an invocation on the first object from the second object, via the proxy agent;
there being no open TCP/IP connection between the first object and the proxy for at least a portion of the period between the time the proxy reference is received and the invocation is received.

39. The method of claim 38, wherein the identifier of the first object sent to the second object is encrypted.

40. The method of claim 38, wherein the identifier comprises an object reference.

41. The method of claim 38, wherein the identifier comprises an object id.

42. The method of claim 38, wherein the proxy agent uses the identifier to invoke the first object.

43. A computer readable medium comprising data representing computer executable instructions for carrying out the method of claims 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 38, 39, 40, 41, and 42.
